(19) United States
(12) Patent Application Publication
(10) Pub. No.: US 2024/0211549 A1
(43) Pub. Date: Jun. 27, 2024

(54) METHODS AND APPARATUS FOR PRIVATE SYNTHETIC DATA GENERATION

(71) Applicant: Intel Corporation, Santa Clara, CA (US)

(72) Inventors: Marius Arvinte, Portland, OR (US); Brandon Edwards, Portland, OR (US); Cory Cornelius, Portland, OR (US); Jason Martin, Beaverton, OR (US); Sebastian Szyller, Helsinki (FI); Micah Sheller, Hillsboro, OR (US); Nageen Himayat, Danville, CA (US)

(21) Appl. No.: 18/591,640

(22) Filed: Feb. 29, 2024

(51) Int. Cl. G06F 21/10

(52) U.S. Cl. CPC G06F 21/101

(57) ABSTRACT

An example apparatus includes interface circuitry, machine-readable instructions, and at least one processor circuit to be programmed by the machine-readable instructions to access a first set of samples associated with a diffusion model, the first set of samples including a plurality of input data samples, generate a representation of the first set of samples, sample the representation of the first set of samples to generate a representation of a second set of samples, and generate the second set of samples from the representation of the second set of samples, the second set of samples including a plurality of output data samples, an output data sample corresponding to an input data sample and being different from the corresponding input data sample.

### FIELD OF THE DISCLOSURE

This disclosure relates generally to neural networks, and, more particularly, to methods and apparatus for private synthetic data generation.

### BACKGROUND

Data-driven approaches involve privacy concerns associated with leakage of sensitive information about individual users. For example, training samples can be reconstructed from deep learning models. Differential privacy mitigates existing privacy concerns by ensuring that information about individual samples in the original data cannot be inferred based on algorithm outputs. Differential private synthetic data is used to generate synthetic datasets that are statistically similar to the original data while maintaining differential privacy.

### BRIEF DESCRIPTION OF THE DRAWINGS

FIG. 1 is a block diagram of a first implementation of synthetic data generator circuitry to rotate a database of latent codes.

FIG. 2 is a block diagram of a second implementation of the synthetic data generator circuitry of FIG. 1 to decode latent code using two sets of functionals.

FIG. 3 is a block diagram of a third implementation of the synthetic data generator circuitry of FIGS. 1-2 including the first implementation of FIG. 1 and the second implementation of FIG. 2.

FIG. 4 is a flowchart representative of example machine-readable instructions and/or example operations that may be executed, instantiated, and/or performed by example programmable circuitry to implement the example synthetic data generator circuitry of FIGS. 1-3.

FIG. 5 is a flowchart representative of example machine-readable instructions and/or example operations that may be executed, instantiated, and/or performed by example programmable circuitry to implement the example synthetic data generator circuitry of FIGS. 1-3 to generate output latent code(s) based on vectorization and database rotation.

FIG. 6 is a flowchart representative of example machine-readable instructions and/or example operations that may be executed, instantiated, and/or performed by example programmable circuitry to implement the example synthetic data generator circuitry of FIGS. 1-3 to generate output latent code(s) based on curve generation and reverse diffusion.

FIG. 7 is a block diagram of an example processing platform including programmable circuitry structured to execute, instantiate, and/or perform the example machine readable instructions and/or perform the example operations of FIGS. 4-6 to implement the synthetic data generator circuitry of FIGS. 1-3.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 4-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Modern machine learning models rely on increasingly large datasets with significant amounts of training data. However, sourcing large datasets in privacy-sensitive domains is challenging. In some examples, generative models are trained on sensitive data to provide access to synthetic data for use in training downstream models. Overparameterized neural networks provide minimal privacy to data used during training, such that an adversary can recover training images of deep classifiers using network gradients or reproduce training text sequences. In some examples, generative models can overfit directly, producing data that is indistinguishable from the data the generative models were trained on. In some contexts, this can raise copyright concerns. Diffusion models (DMs) are a powerful class of generative models used for image synthesis. For example, a diffusion process perturbs the data towards random noise and a deep neural network is used to denoise the data. Known methods combine differential privacy with score-based diffusion models to enforce the privacy of diffusion models. Other approaches include changing the sampling procedure and enforcing diversity with an additional guidance term.

Methods and apparatus disclosed herein perform private synthetic data generation using score-based diffusion models. In examples disclosed herein, private synthetic data generation can be performed to ensure that sampled data is distinct from a given set using (1) a functional formulation of an ordinary differential equation (ODE), (2) a latent space design method associated with neural ODE class-based methods (e.g., including sampling from score-based diffusion models), or (3) a combination of these two techniques. For example, methods and apparatus disclosed herein generate new samples from a score-based diffusion model that are different from any samples in a fixed, finite set of samples that include privacy-based characteristics (e.g., a forbidden set of samples). In particular, methods and apparatus disclosed herein only affect the starting point of the sampling process and utilize the exact invertibility of flow models, guaranteeing that resulting synthetic data samples are different from the forbidden samples. For example, the forbidden set of samples (e.g., from a copyright work, data associated with private information, etc.) can be selected as the training set, such that the generated samples are eliminated from the training set associated with the forbidden samples. As such, generation of samples that are not associated with the forbidden set of samples be used to address copyright issues associated with samples generated by diffusion models. Methods and apparatus disclosed herein can be applied to any model in the neural ODE class, such as the score-based diffusion models or flow matching models. For example, methods and apparatus disclosed herein eliminate the need for re-training and/or modification of model-associated weights for a pre-trained diffusion model.

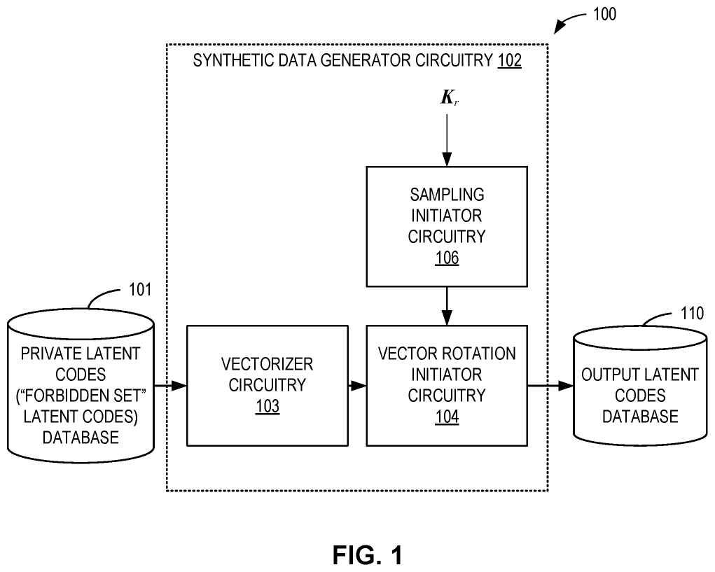

FIG. 1 is a block diagram of a first implementation 100 of synthetic data generator circuitry 102 to rotate a database of latent codes. The synthetic data generator circuitry 102 of FIG. 1 may be instantiated (e.g., creating an instance of, bring into being for any length of time, materialize, implement, etc.) by programmable circuitry such as a Central Processing Unit (CPU) executing first instructions. Additionally or alternatively, the synthetic data generator circuitry 102 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

In the example of FIG. 1, the first implementation 100 includes a private latent codes database 101, vectorizer circuitry 103, vector rotation initiator circuitry 104, sampling initiator circuitry 106, and an output latent codes database 110.

As described in more detail below, methods and apparatus disclosed herein generate synthetic versions of private latent codes, where the private latent codes are associated with score-based diffusion models. For example, score-based diffusion models involve the gradual diffusion of data distribution towards a given noise distribution using a stochastic differential equation (SDE). In some examples, an SDE can be used to convert data x to noise via a continuous process indexed by a time variable t that runs from 0 to 1, as shown in accordance with Equation 1:

$$dx = f ( x , t ) dt + g ( t ) dw \qquad Equation 1$$

For a class of approaches, an example first function ƒ decreases monotonically, while an example second function g increases, denoting that as time t moves forward, the signal portion of the SDE decays and the noise portion increases proportionally. Running this process in reverse results in sampling, generating the production of natural images from noise in modern diffusion models. In general, there are no other constraints on the functions ƒ and g, which can be freely selected. In examples disclosed herein, the synthetic data generator circuitry 102 generates a pair off and g functions from a family of functions, such that a given sample is as far away as possible from a fixed set of “forbidden samples” associated with the private latent codes database 101, as described in more detail below.

Based on the concept of reverse flow, modern diffusion models can be characterized by a SDE where time flows in reverse, as shown in connection with Equation 2:

$$dx = f ( x , t ) dt - {g ( t )}^{2} {∇}_{x} log {p}_{t} ( x ) dt + g ( t ) dw \qquad Equation 2$$

In the example of Equation 2, ∇ₓ logpₜ(x) represents a gradient of the log-density (e.g., the score function) at an arbitrary time t, at query sample x. For example, modern diffusion model-based learning occurs via a deep neural network, represented by s_{θ}(x,t)˜∇ₓ log pt(x).

Additionally, an ordinary differential equation (ODE) exists which has exactly the same marginal densities as an SDE, as shown in accordance with Equation 3:

$$dx = f ( x , t ) dt - \frac{1}{2} {g ( t )}^{2} {∇}_{x} log p ( x ) dt \qquad Equation 3$$

As such, “sampling” a sample x₀ can be viewed as solving a differential equation with the initial condition given by a latent code x1, generally chosen from an independent and identically distributed Gaussian distribution. When the ODE formulation and an ODE-based solver is used, this process is completely deterministic and invertible, and a sample x₀ can be “encoded” back to recover the sample's latent code x₁ by solving the ODE of Equation 3 in reverse-time. For example, known methods of private synthetic data generation include the use of publicly available software that uses fixed grid ODE algorithms to sample from the latest generation of stable diffusion models.

In examples disclosed herein, latent code differs from the latent code associated with Latent Diffusion Models (LDM), where the code represents a compressed version of the sample. In examples disclosed herein, latent code is exactly the same size as an original sample from which the latent code is derived. For example, all diffusion models associated with examples disclosed herein are trained directly in input space. However, this does not preclude the use of LDM-type approaches, such that the methods and apparatus disclosed herein can be combined with latent codes of the compressed latent codes associated with using LDM-based approaches.

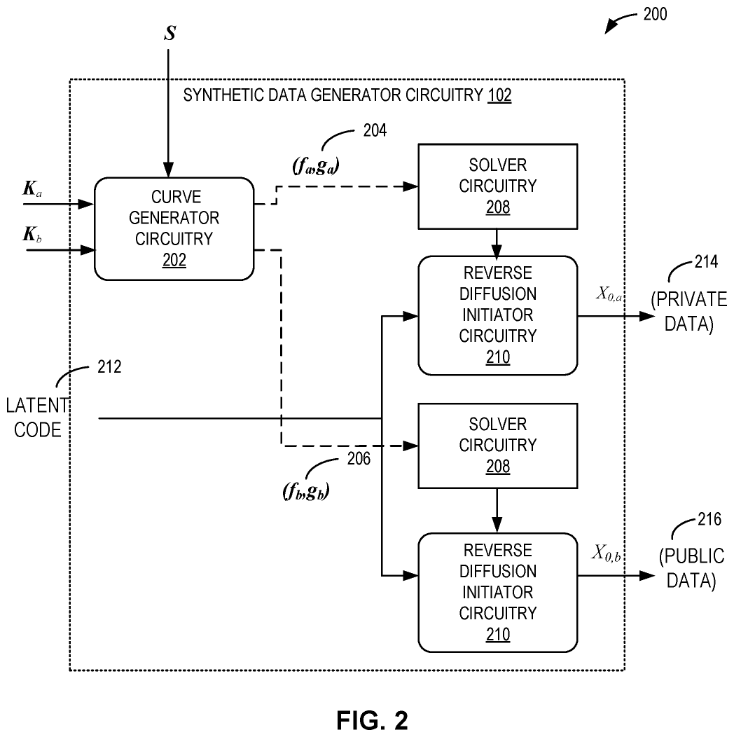

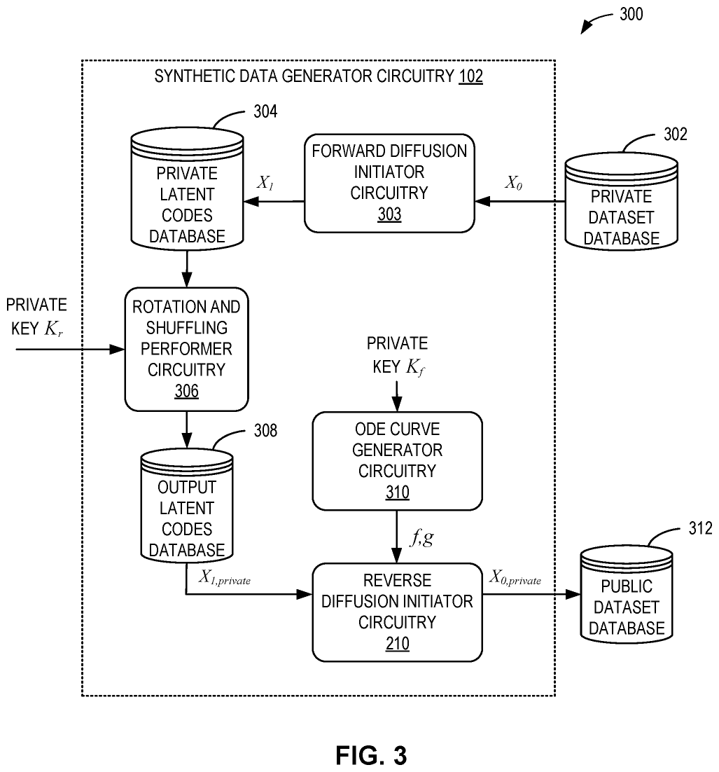

As described in more detail in connection with FIGS. 1-3, methods and apparatus disclosed herein introduce two privacy mechanisms associated with score-based diffusion models. A first privacy mechanism for private data generation focuses on latent code decoding using one pair of functionals and a second privacy mechanism for private data generation focuses on latent code decoding using an ODE solver with two pairs of functions. In the first privacy mechanism described in connection with FIG. 1, differences between the resulting samples are proportional to the difference between the original codes. In the second privacy mechanism described in connection with FIG. 2, the resulting samples have differences that are proportional to the integral of the sum of absolute differences between two sets of curves generated based on a curve generator module (e.g., used to generate the time-dependent functions ƒ and g). A third privacy mechanism for private data generation includes a combination of the first and second privacy mechanisms, as described in connection with FIG. 3.

In the example of FIG. 1, the private latent codes database 101 includes private latent codes corresponding to data having privacy-based characteristics (e.g., linking data to an individual). For example, the private latent codes database 101 includes data that can be associated with an individual (e.g., medical image scans associated with patient-based data, audio-based data linked to an individual's voice, etc.). As such, the private latent codes database 101 includes “forbidden sets” of latent codes that include private data and/or data features that can be tied directly to the original raw data. For example, information about individual samples in the original data can be inferred using the private latent codes associated with the private latent codes database 101. The private latent codes database 101 of the illustrated example of FIG. 1 can be implemented by any memory, storage device and/or storage disc for storing data such as flash memory, magnetic media, optical media, etc. Furthermore, the data stored in the example private latent codes database 101 can be in any data format such as binary data, comma delimited data, tab delimited data, structured query language (SQL) structures, image data, etc.

The vectorizer circuitry 103 performs vectorization of the private latent codes in the private latent codes database 101. For example, the vectorizer circuitry 103 vectorizes each entry in the set of private latent codes of the private latent codes database 101. In some examples, the vectorizer circuitry 103 vectorizes the private latent codes such that each private latent code is vectorized (e.g., flattened) to a one-dimensional vector. In some examples, the vectorizer circuitry 103 coverts irregular nested data parallel code into regular flat data parallel code.

The vector rotation initiator circuitry 104 performs vector rotation of the vectorized private latent code. For example, the vector rotation initiator circuitry 104 performs vector rotation using R degrees of freedom based on input from a degree of freedom sampler associated with the sampling initiator circuitry 106. The vector is rotated with each of the R angles, such that the order of operations does not matter given that angle rotation is commutative. In some examples, the vector rotation initiator circuitry 104 generates a high-dimensional rotation matrix for each R angle, or a single high-dimensional rotation matrix for all R angles simultaneously.

The sampling initiator circuitry 106 performs degree of freedom sampling based on a private key input (Kr). In some examples, the private key Kᵣ is used in a pseudo-random number generator (RNG) module to sample a vector of R angles uniformly and independently in the [−π, π]interval. The vector rotation initiator circuitry 104 subsequently performs vector rotation of the vectorized private latent code based on the vector of R angles. For example, the vector rotation initiator circuitry 104 repeats the vector rotation process for all private latent codes of the private latent codes database 101 using the same set of angles.

The output latent codes database 110 receives the rotated vectorized private latent code, which represents the public output latent code. The public output latent code is a synthetic version of the private latent code which represents a new dataset that is not associated with any privacy-based characteristics that would link the original data to an individual. For example, synthetic data can include an audio that has a synthesized voice of the original audio recording, masking the voice of the speaker. Likewise, a synthesized version of a text can be generated to avoid copying an original text on which the synthesized text is based, masking the source and/or features of the original text. As such, the original latent code is changed into numerical vectors, rotated to generate a different version of the latent code based on a set degree of freedoms, and a synthetic version of the latent code is output that can be used for purposes of training a neural network without compromising the privacy features of the original latent code training dataset.

The output latent codes database 110 of the illustrated example of FIG. 1 can be implemented by any memory, storage device and/or storage disc for storing data such as flash memory, magnetic media, optical media, etc. Furthermore, the data stored in the output latent codes database 110 can be in any data format such as binary data, comma delimited data, tab delimited data, structured query language (SQL) structures, image data, etc.

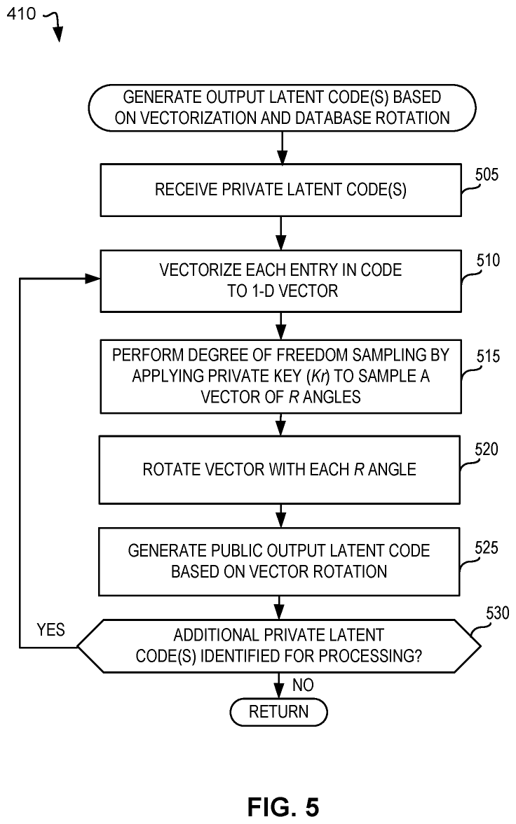

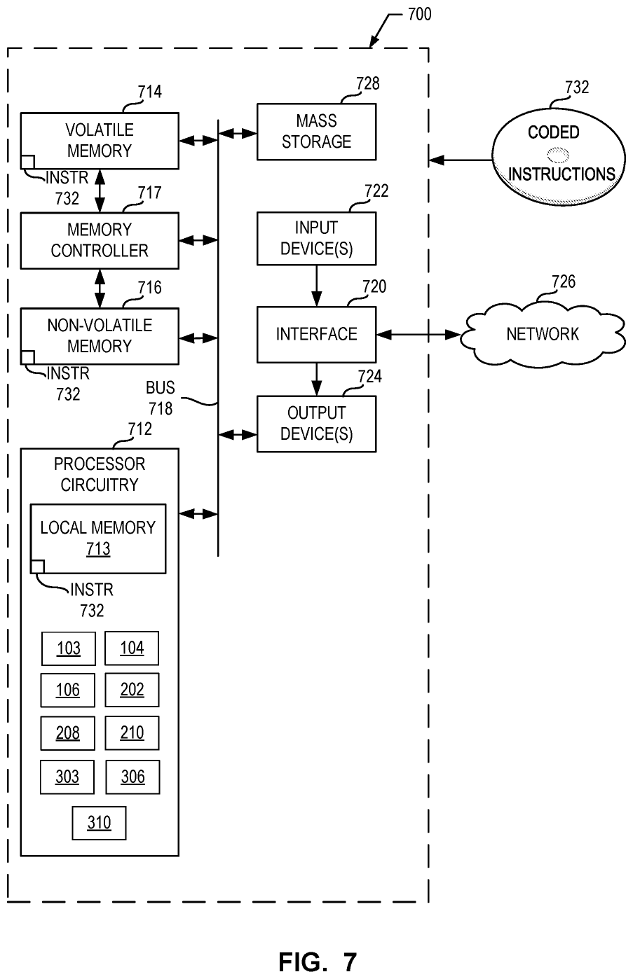

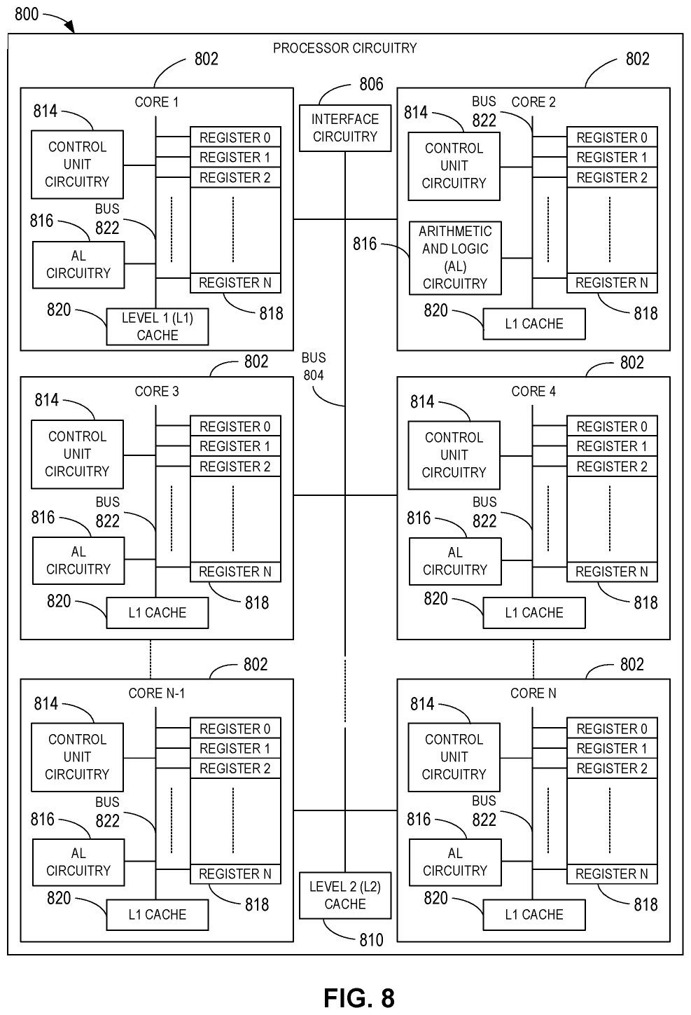

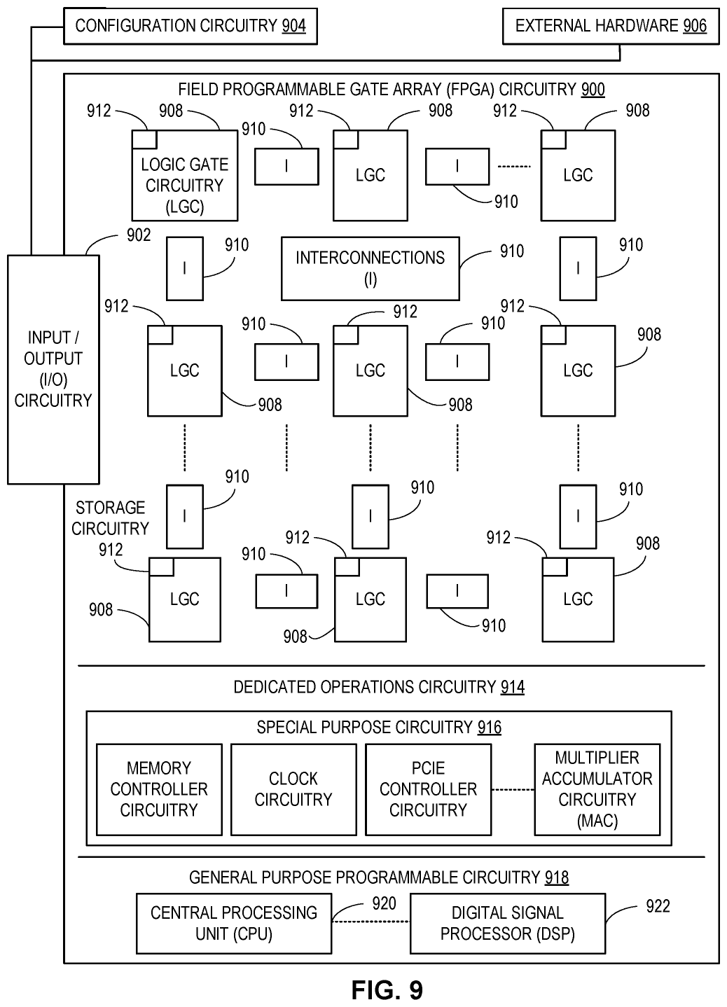

In some examples, the apparatus includes means for performing vectorization. For example, the means for performing vectorization may be implemented by vectorizer circuitry 103. In some examples, the vectorizer circuitry 103 may be instantiated by programmable circuitry such as the example programmable circuitry 712 of FIG. 7. For instance, the vectorizer circuitry 103 may be instantiated by the example microprocessor 800 of FIG. 8 executing machine executable instructions such as those implemented by at least block 510 of FIG. 5. In some examples, the vectorizer circuitry 103 may be instantiated by hardware logic circuitry, which may be implemented by an ASIC, XPU, or the FPGA circuitry 900 of FIG. 9 structured to perform operations corresponding to the machine readable instructions. Additionally or alternatively, the vectorizer circuitry 103 may be instantiated by any other combination of hardware, software, and/or firmware. For example, the vectorizer circuitry 103 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for vector rotation. For example, the means for vector rotation may be implemented by vector rotation initiator circuitry 104. In some examples, the vector rotation initiator circuitry 104 may be instantiated by programmable circuitry such as the example programmable circuitry 712 of FIG. 7. For instance, the vector rotation initiator circuitry 104 may be instantiated by the example microprocessor 800 of FIG. 8 executing machine executable instructions such as those implemented by at least block 520 of FIG. 5. In some examples, the vector rotation initiator circuitry 104 may be instantiated by hardware logic circuitry, which may be implemented by an ASIC, XPU, or the FPGA circuitry 900 of FIG. 9 structured to perform operations corresponding to the machine readable instructions. Additionally or alternatively, the vector rotation initiator circuitry 104 may be instantiated by any other combination of hardware, software, and/or firmware. For example, the vector rotation initiator circuitry 104 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for sampling. For example, the means for sampling may be implemented by sampling initiator circuitry 106. In some examples, the sampling initiator circuitry 106 may be instantiated by programmable circuitry such as the example programmable circuitry 712 of FIG. 7. For instance, the sampling initiator circuitry 106 may be instantiated by the example microprocessor 800 of FIG. 8 executing machine executable instructions such as those implemented by at least block 515 of FIG. 5. In some examples, the sampling initiator circuitry 106 may be instantiated by hardware logic circuitry, which may be implemented by an ASIC, XPU, or the FPGA circuitry 900 of FIG. 9 structured to perform operations corresponding to the machine readable instructions. Additionally or alternatively, the sampling initiator circuitry 106 may be instantiated by any other combination of hardware, software, and/or firmware. For example, the sampling initiator circuitry 106 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

FIG. 2 illustrates an example second implementation 200 of the synthetic data generator circuitry 102 of FIG. 1 to decode latent code using two sets of functionals. In the example of FIG. 2, the second implementation 200 includes curve generator circuitry 202, solver circuitry 208, reverse diffusion initiator circuitry 210, function pairs (fa, g) and (f_{b}, g_{b}) 204, 206, latent code input 212, private data output 214, and public data output 216.

The curve generator circuitry 202 generates the time-dependent functions ƒ and g (e.g., pairs of functions (ƒₐ, gₐ) and (ƒ_{b}, g_{b}) 204, 206). In examples disclosed herein, functions 204, 206 are used in an ODE numerical solver routine (e.g., using solver circuitry 208), in conjunction with the latent code input 212 from which a synthetic sample is produced, yielding the output sample(s) 214, 216 via a reverse diffusion process performed using the reverse diffusion initiator circuitry 210. In some examples, the curve generator circuitry 202, given access to the private dataset, identifies a set of functions (ƒ, g) such that the distance of the decoded sample is maximized with respect to the forbidden set x_{0,i}, while a specific latent code xᵢ from the training set is used. Forcing the latent code to be x₁ ensures that the latent code is a valid code. For example, the curve generator circuitry 202 can perform the maximization using an optimization shown in connection with Equation 4:

$${max}_{f , g} {min}_{i} {‖ ode\_solver ( f , g , {x}_{1} ) - {x}_{0 , i} ‖}^{2} \qquad Equation 4$$

In the example of Equation 4, the outer maximization is generally difficult, because the functions ƒ and g are scalar functions rather than variables, and the ODE solver routine is generally complicated. In the example of FIG. 2, the curve generator circuitry 202 uses a piecewise linear curve generator from a number of S segments. In this case, the parameters Kₐ, K_{b} contain the number of segments and the slope of each segment. In some examples, the curve generator circuitry 202 uses a family of monotonic polynomials on the interval [0, 1] as ODE curves, and their coefficients as the private key(s). For example, the higher the degree of polynomials, the larger the number of degrees of freedom.

The solver circuitry 208 receives the time-dependent functions (fa, ga) and (ƒ_{b}, g_{b}) 204, 206 generated by the curve generator circuitry 202. The solver circuitry 208 implements a solver using (fa, g) 204 and (ƒ_{b}, g_{b}) 206. For example, the solver circuitry 208 implements an ODE numerical solver routine to yield an output sample with a reverse diffusion process initiated using the reverse diffusion initiator circuitry 210. For example, if the same latent code xᵢ is decoded by running an ODE solver with two pairs of functions (ƒₐ, gₐ) and (ƒ_{b}, g_{b}), then the two resulting samples x₀,a (e.g., private data) and x_{o,b} (e.g., public data) are different and their difference is proportional to the integral of the sum of absolute differences between the two sets of curves.

The reverse diffusion initiator circuitry 210 performs iterative reverse diffusion using output(s) from the solver circuitry 208. For example, the reverse diffusion initiator circuitry 210 performs iterative reverse diffusion on the output(s) from the solver circuitry 208. For example, iterative reverse diffusion involves removal of Gaussian noise from the data samples. The reverse diffusion initiator circuitry 210 outputs private data 214 (e.g., private latent code X_{0,a}) based on the (ƒₐ, gₐ) function 204 and outputs public data 216 (e.g., public latent code X_{0,b}) based on the (ƒ_{b}, g_{b}) function 206.

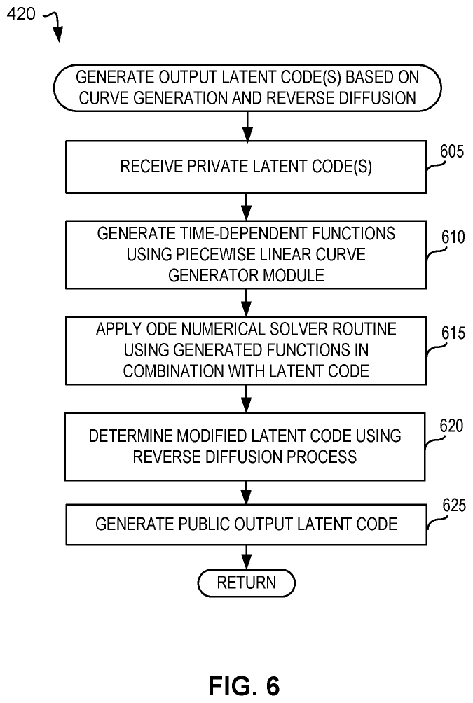

In some examples, the apparatus includes means for generating a curve. For example, the means for generating a curve may be implemented by curve generator circuitry 202. In some examples, the curve generator circuitry 202 may be instantiated by programmable circuitry such as the example programmable circuitry 712 of FIG. 7. For instance, the curve generator circuitry 202 may be instantiated by the example microprocessor 800 of FIG. 8 executing machine executable instructions such as those implemented by at least block 610 of FIG. 6. In some examples, the curve generator circuitry 202 may be instantiated by hardware logic circuitry, which may be implemented by an ASIC, XPU, or the FPGA circuitry 900 of FIG. 9 structured to perform operations corresponding to the machine readable instructions.

Additionally or alternatively, the curve generator circuitry 202 may be instantiated by any other combination of hardware, software, and/or firmware. For example, curve generator circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for solving a function. For example, the means for solving a function may be implemented by solver circuitry 208. In some examples, the solver circuitry 208 may be instantiated by programmable circuitry such as the example programmable circuitry 712 of FIG. 7. For instance, the solver circuitry 208 may be instantiated by the example microprocessor 800 of FIG. 8 executing machine executable instructions such as those implemented by at least block 615 of FIG. 6. In some examples, the solver circuitry 208 may be instantiated by hardware logic circuitry, which may be implemented by an ASIC, XPU, or the FPGA circuitry 900 of FIG. 9 structured to perform operations corresponding to the machine readable instructions. Additionally or alternatively, the solver circuitry 208 may be instantiated by any other combination of hardware, software, and/or firmware. For example, solver circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for initiating reverse diffusion. For example, the means for initiating reverse diffusion may be implemented by reverse diffusion initiator circuitry 210. In some examples, the reverse diffusion initiator circuitry 210 may be instantiated by programmable circuitry such as the example programmable circuitry 712 of FIG. 7. For instance, the reverse diffusion initiator circuitry 210 may be instantiated by the example microprocessor 800 of FIG. 8 executing machine executable instructions such as those implemented by at least block 620 of FIG. 6. In some examples, the reverse diffusion initiator circuitry 210 may be instantiated by hardware logic circuitry, which may be implemented by an ASIC, XPU, or the FPGA circuitry 900 of FIG. 9 structured to perform operations corresponding to the machine readable instructions. Additionally or alternatively, the reverse diffusion initiator circuitry 210 may be instantiated by any other combination of hardware, software, and/or firmware. For example, reverse diffusion initiator circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

FIG. 3 illustrates an example third implementation 300 of the synthetic data generator circuitry 102 of FIGS. 1-2 including the first implementation 100 of FIG. 1 and the second implementation 200 of FIG. 2. In the example of FIG. 3, the third implementation 300 includes a private dataset database 302, forward diffusion initiator circuitry 303, a private latent codes database 304, rotation and shuffling performer circuitry 306, an output latent codes database 308, ODE curve generator circuitry 310, the reverse diffusion initiator circuitry 210 of FIG. 2, and a public dataset database 312. In the example of FIG. 3, a private set (e.g., training set) of latent codes from the private dataset database 302 can be rotated using the first implementation 100 of FIG. 1 and decoded using a specific set of functions ƒ and g, in accordance with the second implementation 200 of FIG. 2. As such, the generated synthetic samples can be as different from the training set as possible.

The forward diffusion initiator circuitry 303 performs iterative forward diffusion on data samples X₀ from the private dataset database 302. For example, the forward diffusion initiator circuitry 303 applies forward diffusion by iteratively adding Gaussian noise to the data samples X₀.

The rotation and shuffling performer circuitry 306 outputs a modified latent code (e.g., x₁,private) such that the modified latent code is maximally different from any of the forbidden latent codes (e.g., in the private latent codes database 304). In examples disclosed herein, deterministic forward diffusion via an ODE solver is exactly invertible, such that forbidden latent codes correspond exactly to the forbidden samples. For example, the resulting code should obey the latent distribution as much as possible for the sample to look realistic but still be far away from the forbidden set. Such modification of the code results from the ODE and training of the score-based diffusion model itself, which maps the real sample distribution to the latent distribution. In some examples, the latent distribution is Gaussian, and the rotation and shuffling performer circuitry 306 performs rotation and shuffling on a randomly sampled latent code x₁. Both operations of rotation and shuffling preserve identical and independently distributed Gaussian vectors, including all associated statistics of the Gaussian vectors. For example, the rotation and shuffling performer circuitry 306 identifies the desired rotation and shuffling patterns using an optimization as shown in connection with Equation 5:

$${max}_{R , S} {min}_{i} {‖ ode\_solver ( R ( S ( {x}_{1} ) ) ) - {x}_{0 , i} ‖}^{2} \qquad Equation 5$$

In general, the space of possible rotation and shuffling operations scales exponentially with the dimension of the signal. For example, the rotation and shuffling performer circuitry 306 can use pre-determined sets R_{D}, S_{D} for the two operations to perform an approximate search within these sets using an ODE solver, where x₀, corresponds to the forbidden latent code set (e.g., stored in the private latent codes database 304). In some examples, the combination of the first implementation 100 of FIG. 1 and the second implementation 200 of FIG. 2 shown in FIG. 3 can be formulated as a single optimization problem, such that both implementations are searched for the ODE functional curves and the rotation and shuffling operators in accordance with Equation 6, including the pre-determined sets R_{D}, S_{D} and functions ƒ and g:

$${max}_{f , g , R , S} {min}_{i} {‖ ode\_solver ( f , g , R ( S ( {x}_{1} ) ) ) - {x}_{0 , i} ‖}^{2} \qquad Equation 6$$

In examples disclosed herein, the samples generated can be single private samples distinct from the input forbidden samples or, when more samples are needed, generation can occur sequentially, adding each sample to the forbidden set of latent code samples as the samples are generated over time.

The ODE curve generator circuitry 310 maximizes the distance between decoded samples. In the example of FIG. 3, the ODE curve generator circuitry 310 receives a private key (K_{ƒ}) to generate time-dependent functions ƒ and g. In examples disclosed herein, functions ƒ and g are used in conjunction with modified latent code (e.g., x_{1,private}) output samples from the output latent codes database 308. For example, if two different latent codes x_{1,a} and x_{1,b} are decoded using the same (ƒ, g) pair, then the resulting samples x₀,a and x_{o,b} are guaranteed to be different, with their difference being proportional to the difference between the original codes, such that the entire process of sampling is distance-preserving. For example, a first set of samples (e.g., private latent codes) can include first and second samples, a second set of samples (e.g., public output latent codes) can include third and fourth samples corresponding to the first and second samples, where all samples of the second set of samples are absent from the first set of samples, and a difference between the third and fourth samples is proportional to a difference between the first and second samples.

The reverse diffusion initiator circuitry 210 performs iterative reverse diffusion on modified latent code (e.g., x₁,private) output samples originating from the output latent codes database 308. The iterative reverse diffusion involves removal of Gaussian noise from the output samples to generate synthetic latent code (e.g., x_{0,private}) and store the synthetic latent code in the public dataset database 312.

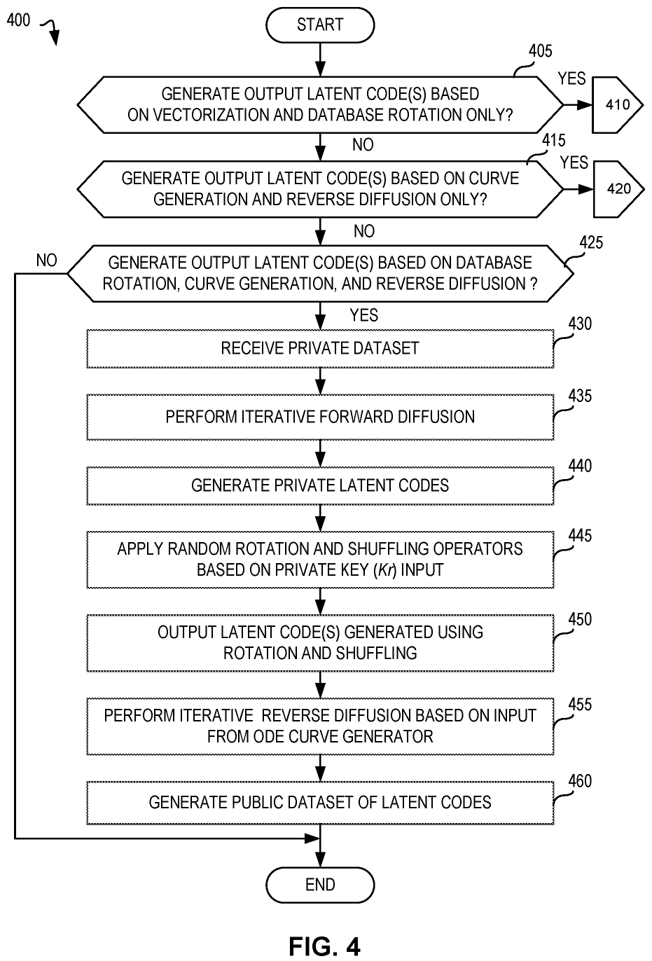

In some examples, the apparatus includes means for performing forward diffusion. For example, the means for performing forward diffusion may be implemented by forward diffusion initiator circuitry 303. In some examples, the forward diffusion initiator circuitry 303 may be instantiated by programmable circuitry such as the example programmable circuitry 712 of FIG. 7. For instance, the forward diffusion initiator circuitry 303 may be instantiated by the example microprocessor 800 of FIG. 8 executing machine executable instructions such as those implemented by at least block 435 of FIG. 4. In some examples, the forward diffusion initiator circuitry 303 may be instantiated by hardware logic circuitry, which may be implemented by an ASIC, XPU, or the FPGA circuitry 900 of FIG. 9 structured to perform operations corresponding to the machine readable instructions. Additionally or alternatively, the forward diffusion initiator circuitry 303 may be instantiated by any other combination of hardware, software, and/or firmware. For example, forward diffusion initiator circuitry 303 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for performing data rotation and shuffling. For example, the means for performing data rotation and shuffling may be implemented by rotation and shuffling performing circuitry 306. In some examples, the rotation and shuffling performing circuitry 306 may be instantiated by programmable circuitry such as the example programmable circuitry 712 of FIG. 7. For instance, the rotation and shuffling performing circuitry 306 may be instantiated by the example microprocessor 800 of FIG. 8 executing machine executable instructions such as those implemented by at least block 445 of FIG. 4. In some examples, the rotation and shuffling performing circuitry 306 may be instantiated by hardware logic circuitry, which may be implemented by an ASIC, XPU, or the FPGA circuitry 900 of FIG. 9 structured to perform operations corresponding to the machine readable instructions. Additionally or alternatively, the rotation and shuffling performing circuitry 306 may be instantiated by any other combination of hardware, software, and/or firmware. For example, rotation and shuffling performing circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for generating an ODE curve. For example, the means for generating an ODE curve may be implemented by ODE curve generator circuitry 310. In some examples, the ODE curve generator circuitry 310 may be instantiated by programmable circuitry such as the example programmable circuitry 712 of FIG. 7. For instance, the ODE curve generator circuitry 310 may be instantiated by the example microprocessor 800 of FIG. 8 executing machine executable instructions such as those implemented by at least block 455 of FIG. 4. In some examples, the ODE curve generator circuitry 310 may be instantiated by hardware logic circuitry, which may be implemented by an ASIC, XPU, or the FPGA circuitry 900 of FIG. 9 structured to perform operations corresponding to the machine readable instructions. Additionally or alternatively, the ODE curve generator circuitry 310 may be instantiated by any other combination of hardware, software, and/or firmware. For example, ODE curve generator circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the synthetic data generator circuitry 102 is illustrated in FIGS. 1-3, one or more of the elements, processes and/or devices illustrated in FIGS. 1-3 may be combined, divided, re-arranged, omitted, eliminated and/or implemented in any other way. Further, the example vectorizer circuitry 103, the example vector rotation initiator circuitry 104, the example sampling initiator circuitry 106, the example curve generator circuitry 202, the example solver circuitry 208, the example reverse diffusion initiator circuitry 210, the example forward diffusion initiator circuitry 303, the example rotation and shuffling performer circuitry 306, the example ODE curve generator circuitry 310, and/or, more generally, the example synthetic data generator circuitry 102 of FIGS. 1-3 may be implemented by hardware, software, firmware and/or any combination of hardware, software and/or firmware. Thus, for example, any of the example vectorizer circuitry 103, the example vector rotation initiator circuitry 104, the example sampling initiator circuitry 106, the example curve generator circuitry 202, the example solver circuitry 208, the example reverse diffusion initiator circuitry 210, the example forward diffusion initiator circuitry 303, the example rotation and shuffling performer circuitry 306, the example ODE curve generator circuitry 310, and/or, more generally, the example synthetic data generator circuitry 102 of FIGS. 1-3 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the synthetic data generator circuitry 102 of FIGS. 1-3 may include one or more elements, processes, and/or devices in addition to, or instead of, those illustrated in FIGS. 1-3, and/or may include more than one of any or all of the illustrated elements, processes and devices.

Flowcharts representative of example machine readable instructions, which may be executed by programmable circuitry to implement and/or instantiate the synthetic data generator circuitry 102 of FIGS. 1-3 and/or representative of example operations which may be performed by programmable circuitry to implement and/or instantiate the synthetic data generator circuitry 102, are shown in FIGS. 4-6. The machine readable instructions may be one or more executable programs or portion(s) of one or more executable programs for execution by programmable circuitry, such as the programmable circuitry 712 shown in the example processor platform 800 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 4-6, many other methods of implementing the example synthetic data generator circuitry 102 of FIGS. 1-3 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 4-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed, instantiated, and/or performed by programmable circuitry to implement the example synthetic data generator circuitry 102 of FIGS. 1-3. The machine-readable instructions and/or the operations 400 of FIG. 4 begin at block 405, at which the synthetic data generator circuitry 102 identifies whether to generate synthetic latent codes based on vectorization and database rotation only (e.g., using the first implementation 100 of FIG. 1). If the synthetic data generator circuitry 102 selects the first implementation, control proceeds to block 410 to implement privacy-preserving synthetic data generation using the first implementation 100, as described in connection with FIG. 5. If the synthetic data generator circuitry 102 determines to proceed with generating the output latent code(s) based on curve generation and reverse diffusion only (e.g., using the second implementation 200 of FIG. 2), at block 415, control proceeds to block 420 to implement privacy-preserving synthetic data generation using the second implementation 200, as described in connection with FIG. 6. If the synthetic data generator circuitry 102 determines to proceed with generating the output latent code(s) based on database rotation, curve generation, and reverse diffusion (e.g., using the third implementation 300 of FIG. 3), at block 425, the forward diffusion initiator circuitry 303 receives data from a private dataset (e.g., private dataset database 302 of FIG. 3), at block 430.

The forward diffusion initiator circuitry 303 performs iterative forward diffusion by iteratively adding Gaussian noise to the data samples, at block 435. The forward diffusion initiator circuitry 303 generates private latent codes from the private dataset and stores the private latent codes in a private latent code database (e.g., private latent codes database 304 of FIG. 3), at block 440. The rotation and shuffling performer circuitry 306 outputs a modified latent code that is maximally different from the private latent code by applying random rotation and shuffling operators based on a private key input, at block 445. For example, the rotation and shuffling performer circuitry 306 performs rotation and shuffling on a randomly sampled latent code x₁, as described in connection with FIG. 3. The rotation and shuffling performer circuitry 306 outputs latent code(s) generated using rotation and shuffling of the input private latent codes, at block 450. The reverse diffusion initiator circuitry 210 performs reverse diffusion on the output latent codes using time-dependent function(s) generated by the ODE curve generator circuitry 310, at block 455. For example, the ODE curve generator circuitry 310 maximizes the distance between decoded samples, as described in connection with FIG. 3. Subsequently, the reverse diffusion initiator circuitry 210 removes Gaussian noise from the output samples to generate synthetic latent code and store the synthetic latent code in a public dataset database, at block 460. In some examples, the synthetic data generator circuitry 102 determines a minimum distance between the synthetic data sample x and any sample x_{0,1} of the forbidden data set in accordance with Equation 7:

$${min}_{i} ‖ x - {x}_{0 , i} ‖ \qquad Equation 7$$

For example, if the synthetic data generator circuitry 102 determines that the distance is above a set threshold for all synthetic samples, this can serve as confirmation of the differences between the forbidden data and resulting synthetic data samples.

FIG. 5 is a flowchart representative of example machine readable instructions and/or example operations 410 that may be executed, instantiated, and/or performed by programmable circuitry to implement the example synthetic data generator circuitry 102 of FIGS. 1-3. The machine-readable instructions and/or the operations 410 of FIG. 5 begin at block 505, at which the vectorizer circuitry 103 receives private latent code input (e.g., from the private latent codes database 101 of FIG. 1). The vectorizer circuitry 103 vectorizes each entry in the latent code to a one-dimensional vector, at block 510. The sampling initiator circuitry 106 performs a degree of freedom sampling by applying a private key to sample a vector of R angles, at block 515. Subsequently, the vector rotation initiator circuitry 104 rotates the vector with respect to each R angle, at block 520. For example, the vector rotation initiator circuitry 104 generates a high-dimensional rotation matrix for each R angle, or a single high-dimensional rotation matrix for all R angles simultaneously. The vector rotation initiator circuitry 104 generates the public output latent code (e.g., synthetic code) based on the vector rotation and stores the latent code in an output latent codes database (e.g., output latent codes database 110 of FIG. 1), at block 525. If the vectorizer circuitry 103 detects additional private latent code(s) to convert into synthetic code, the process repeats until all private latent code(s) are processed, at block 530.

FIG. 6 is a flowchart representative of example machine readable instructions and/or example operations 420 that may be executed, instantiated, and/or performed by programmable circuitry to implement the example synthetic data generator circuitry 102 of FIGS. 1-3. The machine readable instructions and/or the operations 420 of FIG. 6 begin at block 605, at which the curve generator circuitry 202 receives the private latent codes. The curve generator circuitry 202 proceeds to generate time-dependent functions using a piecewise linear curve generator module, at block 610. For example, the curve generator circuitry 202 generates the time-dependent functions ƒ and g (e.g., pairs of functions (ƒₐ, gₐ) and (ƒ_{b}, g_{b}) 204, 206 of FIG. 2). For example, the curve generator circuitry 202 identifies time-dependent functions to maximize a distance of decoded samples with respect to the private latent code (e.g., forbidden set). The solver circuitry 208 applies an ODE numerical solver routine using the generated functions in combination with the latent code, at block 615, as described in more detail in connection with FIG. 2. Subsequently, the reverse diffusion initiator circuitry 210 determines the modified latent code using a reverse diffusion process, at block 620. For example, the reverse diffusion initiator circuitry 210 applies iterative reverse diffusion to remove Gaussian noise from the data samples. The reverse diffusion initiator circuitry 210 generates public output latent code once the reverse diffusion process is complete, at block 625.

FIG. 7 is a block diagram of an example programmable circuitry platform 700 structured to execute and/or instantiate the example machine-readable instructions and/or the example operations of FIGS. 4-6 to implement the example synthetic data generator circuitry 102 of FIGS. 1-3. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example vectorizer circuitry 103, the example vector rotation initiator circuitry 104, the example sampling initiator circuitry 106, the example curve generator circuitry 202, the example solver circuitry 208, the example reverse diffusion initiator circuitry 210, the example forward diffusion initiator circuitry 303, the example rotation and shuffling performer circuitry 306, the example ODE curve generator circuitry 310.

The programmable circuitry 712 of the illustrated example includes a local memory 713 (e.g., a cache, registers, etc.). The programmable circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output devices 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 700 of the illustrated example also includes one or more mass storage devices 728 to store software and/or data. Examples of such mass storage devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 732, which may be implemented by the machine readable instructions of FIGS. 4-6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general purpose microprocessor (e.g., general purpose microprocessor circuitry). The microprocessor 800 executes some or all of the machine readable instructions of the flowcharts of FIGS. 4-6 to effectively instantiate the circuitry of FIGS. 1-3 logic circuits to perform the operations corresponding to those machine readable instructions. In some such examples, the circuitry of FIGS. 1-3 is instantiated by the hardware circuits of the microprocessor 800 in combination with the instructions. For example, the microprocessor 800 may implement multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 4-6.

The cores 802 may communicate by a first example bus 804. In some examples, the first bus 804 may implement a communication bus to effectuate communication associated with one(s) of the cores 802. For example, the first bus 804 may implement at least one of an Inter-Integrated Circuit (I2C) bus, a Serial Peripheral Interface (SPI) bus, a PCI bus, or a PCIe bus. Additionally or alternatively, the first bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2_cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the L1 cache 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer-based operations. In other examples, the AL circuitry 816 also performs floating-point operations. In yet other examples, the AL circuitry 816 may include first AL circuitry that performs integer-based operations and second AL circuitry that performs floating point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 4-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 4-6. In particular, the FPGA 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 4-6. As such, the FPGA circuitry 900 may be configured and/or structured to effectively instantiate some or all of the operations/functions corresponding to the machine readable instructions of the flowcharts of FIGS. 4-6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 4-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 4-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 9. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 902 of FIG. 9 may execute a first portion of the machine readable instructions represented by the flowchart(s) of FIGS. 4-6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 4-6, and/or an ASIC may be configured and/or structured to perform third operation(s)/function(s) corresponding to a third portion of the machine readable instructions represented by the flowcharts of FIGS. 4-7.

It should be understood that some or all of the circuitry of FIGS. 1-3 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIGS. 1-3 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIGS. 1-3 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7 which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

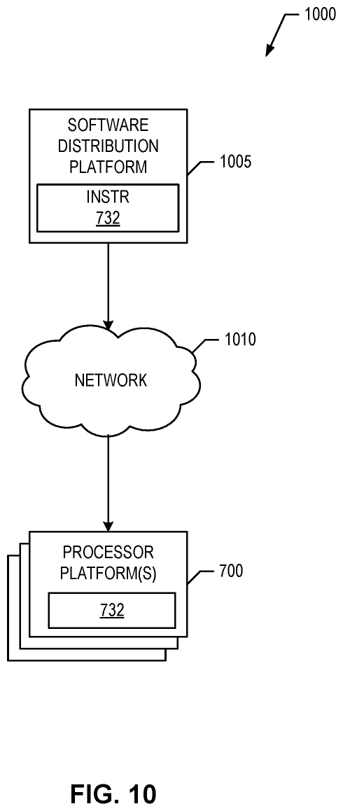

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 4-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 4-6, may be downloaded to the example programmable circuitry platform 700, which is to execute the machine readable instructions 732 to implement the synthetic data generator circuitry 102 of FIGS. 1-3. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein perform private synthetic data generation using score-based diffusion models. In examples disclosed herein, private synthetic data generation can be performed to ensure that sampled data is distinct using (1) a functional formulation of an ordinary differential equation (ODE), (2) a latent space design method associated with neural ODE class-based methods (e.g., including sampling from score-based diffusion models), or (3) a combination of these two privacy-preserving techniques. Generation of samples that are not associated with the private set of samples be used to address copyright issues associated with samples generated by diffusion models.

Example methods, apparatus, systems, and articles of manufacture for private synthetic data generation using score-based diffusion models are disclosed herein. Further examples and combinations thereof include the following:

Example 1 includes an apparatus, comprising interface circuitry, machine-readable instructions, and at least one processor circuit to be programmed by the machine-readable instructions to access a first set of samples associated with a diffusion model, the first set of samples including a plurality of input data samples, generate a representation of the first set of samples, sample the representation of the first set of samples to generate a representation of a second set of samples, and generate the second set of samples from the representation of the second set of samples, the second set of samples including a plurality of output data samples, an output data sample corresponding to an input data sample and being different from the corresponding input data sample.

Example 2 includes the apparatus of example 1, wherein the first set of samples is a private set of samples, the first set of samples corresponds to copyrighted media.

Example 3 includes the apparatus of example 1, wherein one or more of the at least one processor circuit is to vectorize the representation of the first set of samples.

Example 4 includes the apparatus of example 1, wherein the first set of samples includes first and second samples, the second set of samples includes third and fourth samples corresponding to the first and second samples, all samples of the second set of samples absent from the first set of samples, and a difference between the third and fourth samples proportional to a difference between the first and second samples.

Example 5 includes the apparatus of example 1, wherein one or more of the at least one processor circuit is to rotate the representation of the first set of samples using a random rotation.

Example 6 includes the apparatus of example 5, wherein one or more of the at least one processor circuit is to perform the random rotation by generating a high-dimensional rotation matrix for angles in a vector of angles.

Example 7 includes the apparatus of example 6, wherein one or more of the at least one processor circuit is to apply a private key to sample the vector of angles as part of the random rotation.

Example 8 includes at least one non-transitory machine-readable medium comprising machine-readable instructions to cause at least one processor circuit to at least access a first set of samples associated with a diffusion model, the first set of samples including a plurality of input data samples, generate a representation of the first set of samples, sample the representation of the first set of samples to generate a representation of a second set of samples, and generate the second set of samples from the representation of the second set of samples, the second set of samples including a plurality of output data samples, an output data sample corresponding to an input data sample and being different from the corresponding input data sample.

Example 9 includes the at least one non-transitory machine-readable medium of example 8, wherein the first set of samples is a private set of samples, the first set of samples corresponds to copyrighted media.

Example 10 includes the at least one non-transitory machine-readable medium of example 9, wherein the machine-readable instructions are to cause one or more of the at least one processor circuit to wherein one or more of the at least one processor circuit is to vectorize the representation of the first set of samples.

Example 11 includes the at least one non-transitory machine-readable medium of example 8, wherein the first set of samples includes first and second samples, the second set of samples includes third and fourth samples corresponding to the first and second samples, all samples of the second set of samples absent from the first set of samples, and a difference between the third and fourth samples proportional to a difference between the first and second samples.

Example 12 includes the at least one non-transitory machine-readable medium of example 8, wherein the machine-readable instructions are to cause one or more of the at least one processor circuit to rotate the first set of samples using a random rotation.

Example 13 includes the at least one non-transitory machine-readable medium of example 12, wherein the machine-readable instructions are to cause one or more of the at least one processor circuit to perform the random rotation by generating a high-dimensional rotation matrix based on angles in a vector of angles.

Example 14 includes the at least one non-transitory machine-readable medium of example 13, wherein the machine-readable instructions are to cause one or more of the at least one processor circuit to apply a private key to sample the vector of angles as part of the random rotation.

Example 15 includes an apparatus, comprising interface circuitry, machine-readable instructions, and at least one processor circuit to be programmed by the machine-readable instructions to access a first sample associated with a diffusion model, decode the first sample based on two pairs of curves to generate second and third samples, a difference between the second and third samples proportional to an integral of a sum of differences between the curves, and train a neural network based on the second and third samples.

Example 16 includes the apparatus of example 15, wherein the first set of samples is a forbidden set of samples.

Example 17 includes the apparatus of example 15, wherein the first set of samples corresponds to copyrighted media.

Example 18 includes the apparatus of example 15, wherein one or more of the at least one processor circuit is to generate the two pairs of curves based on a piecewise linear curve generator.

Example 19 includes the apparatus of example 15, wherein one or more of the at least one processor circuit is to perform reverse diffusion with an ordinary differential equation (ODE)-based numerical solver.

Example 20 includes the apparatus of example 19, wherein one or more of the at least one processor circuit is to apply a family of monotonic polynomials as ODE-based curves.

Example 21 includes the apparatus of example 20, wherein one or more of the at least one processor circuit is to generate a private key using coefficients of the family of monotonic polynomials.

Example 22 includes at least one non-transitory machine-readable medium comprising machine-readable instructions to cause at least one processor circuit to at least access a first sample associated with a diffusion model, decode the first sample based on two pairs of curves to generate second and third samples, a difference between the second and third samples proportional to an area corresponding to a sum of differences between the curves, and train a neural network based on the second and third samples.

Example 23 includes the at least one non-transitory machine-readable medium of example 22, wherein the first sample is a forbidden sample.

Example 24 includes the at least one non-transitory machine-readable medium of example 22, wherein the area corresponds to an integral of the sum of differences.

Example 25 includes the at least one non-transitory machine-readable medium of example 22, wherein the machine-readable instructions are to cause one or more of the at least one processor circuit to generate the two pairs of curves based on a piecewise linear curve generator.

Example 26 includes the at least one non-transitory machine-readable medium of example 22, wherein the machine-readable instructions are to cause one or more of the at least one processor circuit to perform reverse diffusion with an ordinary differential equation (ODE)-based numerical solver.

Example 27 includes the at least one non-transitory machine-readable medium of example 26, wherein the machine-readable instructions are to cause one or more of the at least one processor circuit to apply a family of monotonic polynomials as ODE-based curves.

Example 28 includes the at least one non-transitory machine-readable medium of example 27, wherein the machine-readable instructions are to cause one or more of the at least one processor circuit to generate a private key using coefficients of the family of monotonic polynomials.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus, comprising:
interface circuitry;
machine-readable instructions; and
at least one processor circuit to be programmed by the machine-readable instructions to:
access a first step of sample associated with a diffusion model, the first set of samples including a plurality of input data samples;
generate a representation of the first set of samples;
sample the representation of the first set of samples to generate a representation of a second set of samples; and
generate the second set of samples from the representation of the second set of samples, the second set of samples including a plurality of output data samples, an output data sample corresponding to an input data sample and being different from the corresponding input data sample.

2. The apparatus of claim 1, wherein the first set of samples is a private set of samples, the first set of samples corresponds to copyrighted media, and one or more of the at least one processor circuitry is to train a neural network based on the second set of samples.

3. The apparatus of claim 1, wherein one or more of the at least one processor circuit is to vectorize the representation of the first set of samples to a one-dimensional vector.

4. The apparatus of claim 1, wherein the first set of samples includes first and second samples, the second set of samples includes third and fourth samples corresponding to the first and second samples, all samples of the second set of samples absent from the first set of samples, and a difference between the third and fourth samples proportional to a difference between the first and second samples.

5. The apparatus of claim 1, wherein one or more of the at least one processor circuit is to rotate the representation of the first set of samples using a random rotation.

6. The apparatus of claim 5, wherein one or more of the at least one processor circuit is to perform the random rotation by generating a high-dimensional rotation matrix for angles in a vector of angles.

7. The apparatus of claim 6, wherein one or more of the at least one processor circuit is to apply a private key to sample the vector of angles as part of the random rotation.

8. At least one non-transitory machine-readable medium comprising machine-readable instructions to cause at least one processor circuit to at least:
access a first set of samples associated with a diffusion model, the first set of samples including a plurality of input data samples;
generate a representation of the first set of samples;
sample the representation of the first set of samples to generate a representation of a second set of samples; and
generate the second set of samples from the representation of the second set of samples, the second set of samples including a plurality of output data samples, an output data sample corresponding to an input data sample and being different from the corresponding input data sample.

9. The at least one non-transitory machine-readable medium of claim 8, wherein the first set of samples corresponds to copyrighted media.

10. The at least one non-transitory machine-readable medium of claim 9, wherein the machine-readable instructions are to cause one or more of the at least one processor circuit to vectorize the representation of the first set of samples.

11. The at least one non-transitory machine-readable medium of claim 8, wherein the first set of samples includes first and second samples, the second set of samples includes third and fourth samples corresponding to the first and second samples, all samples of the second set of samples absent from the first set of samples, and a difference between the third and fourth samples proportional to a difference between the first and second samples.

12. The at least one non-transitory machine-readable medium of claim 8, wherein the machine-readable instructions are to cause one or more of the at least one processor circuit to rotate the first set of samples using a rotation.

13. The at least one non-transitory machine-readable medium of claim 12, wherein the machine-readable instructions are to cause one or more of the at least one processor circuit to perform the rotation by generating a high-dimensional rotation matrix based on angles in a vector of angles.

14. The at least one non-transitory machine-readable medium of claim 13, wherein the machine-readable instructions are to cause one or more of the at least one processor circuit to apply a private key to sample the vector of angles as part of a random rotation.

15. An apparatus, comprising:
interface circuitry;
machine-readable instructions; and
at least one processor circuit to be programmed by the machine-readable instructions to:
access a first sample associated with a diffusion model;
decode the first sample based on two pairs of curves to generate second and third samples, a difference between the second and third samples proportional to an integral of a sum of differences between the curves; and
train a neural network based on the second and third samples.

16. The apparatus of claim 15, wherein the first set of samples is a forbidden set of samples.

17. The apparatus of claim 15, wherein the first set of samples corresponds to copyrighted media.

18. The apparatus of claim 15, wherein one or more of the at least one processor circuit is to generate the two pairs of curves based on a piecewise linear curve generator.

19. The apparatus of claim 15, wherein one or more of the at least one processor circuit is to perform reverse diffusion with an ordinary differential equation (ODE)-based numerical solver.

20. The apparatus of claim 19, wherein one or more of the at least one processor circuit is to apply a family of monotonic polynomials as ODE-based curves.

21-28. (canceled)
